(19) United States
(12) Patent Application Publication
(10) Pub. No.: US 2009/0313558 A1
(43) Pub. Date: Dec. 17, 2009

(54) Semantic Image Collection Visualization

(75) Inventors: Eran Yariv, Zichron Yaakov (IL); Ron Karidi, Herzeliya (IL); Roy Varshavsky, Tel Aviv (IL); Daniel Sitton, Tel Aviv (IL); Oded Elyada, Hod-Hasharon (IL)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 12/137,157

(22) Filed: Jun. 11, 2008

(51) Int. Cl. G06F 7/06; G06F 17/30; G06F 3/048

(52) U.S. Cl. 715/760; 707/4; 707/E17.108

(57) ABSTRACT

A service provides an image collection as a visual preview of content pages having a link in or otherwise related to a current page. A first content page is provided to a user and may have one or more links to additional content pages. Each of the related content pages may have one or more images. Selected images of the one or more content pages are provided in an image collection. The images may be positioned in rows, columns, or some other manner within the collection. The image collection is prepared dynamically from related content pages when the current page is loaded and does not require any software in the currently content page to be changed as the linked content pages change.

### BACKGROUND

Currently, web-based search services allow users to search for web page content based on key words received from the user. Typically, these search services receive a string of text and provide a list of search results. Each entry in the search results usually includes a short description and a URL link to a web site. A user may select one of the URL links to load and view a web page comprising one of the results of the search.

Some search services allow a user to search for images available over the web. These services receive a text string and search for images having meta-data that matches the received string. The results of a typical image search display rows of images with a short description and URL link for each result. A user may go to the URL associated with each result by selecting the image or the URL below it.

Some web sites provide a user experience which provides a first set of content, such as a list of article titles, and provides additional content when a cursor is placed over the first content. For example, a sports-related web site might list several article headings which, when selected, redirect a user to another web page with the complete article. When a user positions a cursor over the heading for an article, the beginning of the article may be displayed in a text box near the heading. Similarly, a web site that offers a movie rental service may provide a first sent of content that lists several movie names and a second set of content comprising a movie image and description when a user positions a cursor over a movie name.

Typically, these informative text boxes and images provided by positioning a cursor over a heading, text or other first set of content are programmed into the web page that provides the first set of content. The web page provides static content about the article or movie that is provided upon detecting the position of the cursor.

Search services that provide text and a URL as search results do not provide a user with much information to determine what the site actually contains. Most websites that appear to “preview” content from another page, such as a web page that previews a web page with a text article, hardcode the preview text into the web page. As a result, if the article changes, the “preview” content in the referencing web page must be changed as well. This requires programming time and resources.

### SUMMARY

The present technology, roughly described, provides a preview of related visual content using an image collection. When a first content page (the context page) is provided to a user per a user request, an image collection is implicitly generated and presented to the user in conjunction with the context page. The image collection is comprised of images that are related to the content of that context page and comprised of selected images from a set of related content pages. The set of related pages may include, for example, one or more of the content pages directly linked from the context page, pages linked from those directly linked pages, and content pages identified to be related via a search algorithm or search engine. The image collection is prepared implicitly when a content page is loaded and does not require any software in the current content page to be changed as the related content pages change.

The image collection, or image cloud, is comprised of images contained in content pages, such as web sites, that are linked to a content page that a user is viewing. The images may be positioned in rows, columns, or some other manner within the collection and are embedded with a URL link corresponding to the page the image is originally from. When a user selects an image within the image collection, the content page in which the image is originally from is then retrieved using the embedded URL and provided to the user.

Images may be processed, by image analysis or some other type of processing, before they are included in the image collection. In some embodiments, the image size, aspect ratio, contrast and other features are compared to thresholds to determine whether the image should be included in the image collection. Images that meet these requirements may still be manipulated before they are placed in an image collection.

An embodiment receives content page data for a first content page requested by a user. The content page data is parsed for identification information for one or more related content pages. The Related content pages found by the parsing are retrieved and images in the retrieved pages are detected. One or more of the detected images are selected to include in an image collection. The image collection is then generated with the selected images and provided to a user.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a block diagram of an embodiment of a system for providing an image collection.

FIG. 2 illustrates a block diagram of another embodiment of a system for providing an image collection.

FIG. 3 illustrates a block diagram of another embodiment of a system for providing an image collection.

FIG. 4 illustrates an example of an image table.

FIG. 5 illustrates a flow chart of an embodiment of a method for generating and providing an image collection.

FIG. 6 illustrates a flow chart of an embodiment of a method for selecting related content page images to include in an image collection.

FIG. 7 illustrates a flow chart of an embodiment of a method for analyzing a selected image.

FIG. 8 illustrates a flow chart of an embodiment of a method for modifying a selected image.

FIG. 9 illustrates a flow chart of an embodiment of a method for gathering image information.

FIG. 10 illustrates a flow chart of an embodiment of a method for providing an image collection to a user.

FIG. 11 illustrates an example of an image collection.

FIG. 12 illustrates an example of a computing environment for use with the present technology.

### DETAILED DESCRIPTION

A preview of related visual content is provided using an image collection. When a first content page (the context page) is provided to a user in response to a user request, an image collection is implicitly generated and presented to the user in conjunction with the context page. The image collection is comprised of images that are related to the content of the context page and comprised of selected images from a set of related content pages. The set of related content pages may include, for example, one or more content pages directly linked from the context page, pages linked from directly linked pages, and content pages identified to be related to the content page via a search algorithm, search engine, or in some other manner. The image collection is prepared implicitly when a content page is loaded. The current content page does not require any software changes or updates as the related content pages change.

The image collection, or image cloud, is comprised of images contained in content pages, such as web sites, that are Related to a content page that a user is viewing. For example, if the first content page being viewed by the user has web links to four other content pages, the image collection may be constructed using images in the four other content pages. The images may be positioned in rows, columns, or some other manifestation within the collection. Additionally, each image in the image collection may be embedded with a URL link corresponding to the page the image is originally from. When a user selects an image within the image collection, the content page in which the image is originally from is then retrieved using the embedded URL and provided to the user. In some embodiments, the URL link feature may have different behavior in thumbnail/big image scenarios.

Images may be processed and/or analyzed before they are included in the image collection. In some embodiments, the image size, aspect ratio, contrast and other features are compared to thresholds to determine whether the image should be included in the image collection. In some embodiments, the content page in which the image is presented may also be analyzed to determine whether images in that page are related to the context page. Images that meet these requirements may still be manipulated before they are placed in an image collection. For example, images may be cropped to remove content determined to be less interesting or to focus on content considered to be more interesting. Html parsing can define the importance of the image context wise, such as how relevant the page is to the user, and interest wise, to determine if the image is title or content. For example, images may be divided into groups of content images and structure images. Content images are related to an article. Structure images include titles, menus, and so on. The present technology may filter images remove structure images and filter and/or otherwise process only relevant content images that are relevant that a user may be interested in. Any of several image processing algorithms may be used to determine different features of an image and what portions should remain or be removed.

The image collection is prepared by an image collection engine. The engine may be implemented as a service side engine, client application, browser application plug-in, or as some other software, hardware or combination of these. In some embodiments, the information can be cached and doesn't need to be processed for every request. The server might have a preprocessed list of relevant pages and images for a list of URLs or any information extracted from the page. It can also have preprocessed information about the page that is viewed. The image collection engine may parse a first context page to identify URLs listed in the code of the page, retrieve the content pages for each listed URL, identify the images in the retrieved content pages, process the images and construct the image collection from the retrieved images. In some embodiments, there might be different parsing depending on content, for example flash sites might have a flash reader and Adobe Acrobat documents might get the images from the document.

The image collection is a tool for providing visual preview information for one or more content pages related to a current context page. The visual nature of the collection allows users to quickly determine the nature of the content pages related to the currently viewed page. Additionally, the image collection is generated at the time the current page is viewed, so the image data provided in the collection is up to date and requires no programming resources to track changes made to the related content pages. Rather, changes made to any related content page image are automatically processed to be included or reflected in a context page at the time the current context page is provided.

In some embodiments, some computer intensive processing can be done in advance. In general there are three types of information that can be handled by offline computation. First, processes that are slow because of a slow network, having them at a local server (via a proxy, local storage or local network storage like using a search engine cached pages)will speed fetching them. Second, processes that require intensive processing can be cached (for example pictures of rendered internet pages as the rendering process is expensive on resources). Third, information gathered from specific service providers and stored (like a data base of pages linking to a specific URL, or a list of URLs that are relevant to a specific keyword). This information can be gathered through open resources or via internal resources (processing a web graph that is an internal resource or crawling the web).

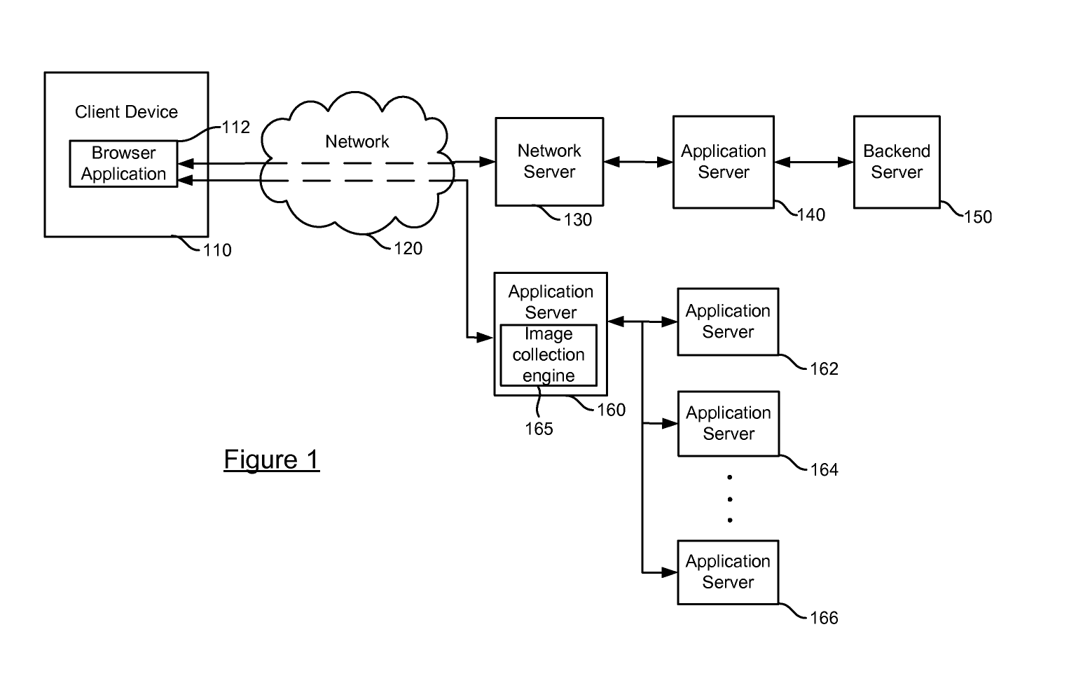

FIG. 1 illustrates a block diagram of an embodiment of a system for providing an image collection. The system of FIG. 1 includes client device 110, network 120, network server 130, application servers 140, 160, 162, 164 and 166, and back end server 150.

Client device 110 includes browser application 112 and communicates with network server 130 over network 120. Browser application 112 may retrieve content from network server 130 over network 120 and provide the content to a user through an interface. In some embodiments, browser application 112 may be implemented using “Internet Explorer” provided by Microsoft Corporation of Redmond, Wash. Image table 118 includes sets of information for one or more images. Each set of image information contained in a content page, such as a web page, which is related to a current content page, or web page, being viewed by a user through browser application 112.

Network 120 may be implemented as the Internet or other WAN, a LAN, intranet, extranet, private network or other network or networks.

Network server 130 is in communication with client device 110 and application server 140. Network server 130 may receive requests from client device 110 over network 120, generate a response and send the response to the client device. Generating a response may include sending a request to application server 140. In some embodiments where network 120 is the Internet, network server 130 may be implemented as a web server and provide web pages to browser application 112 on client device 110. Additionally, in some embodiments, network server 130 may provide a content page with embedded image collection information in the page. The embedded image information may be provided as a hint, toolbar element, other visual form or other information indicating the existence of an image collection associated with the current content page.

Application server 140 may communicate with network server 130 and backend server 150 and contain one or more applications (not illustrated). In some embodiments, application server may respond to requests from network server 130 (web server) to process requests for content pages from client 110. While processing requests from network server 130, application server 140 may send queries or other requests to backend server 150.

Backend server 150 may be implemented as a database, data store, application server, or any other machine which may be queried or receive requests from an application server, including application server 140.

Application servers 160, 162, 164 and 166 may each contain one or more applications that perform operations and provide a result in response to a received request. Each of application servers 160-166 may be implemented as one or more servers and may communicate with one or more network servers, backend servers, or other machines.

Application server 160 includes image collection engine 165 and may communicate with client device 110 and application servers 162-166. In some embodiments,

Image collection engine 175 may construct and provide an image collection to client device 110. In particular, image collection engine 175 may receive or retrieve a requested content page (context page), parse HTML code of the current content page to identify links to other web pages, retrieve the linked and other related web pages and process the pages. Processing the related content pages is performed to identify one or more images in each content page. The images in the related content pages are then processed to determine if they should be included in the image collection. Images that should be included in the image collection are then used to construct the image collection page by image collection engine 175. In some embodiments, the functionality and features illustrated on different application servers and image collection servers may in reality be running on the same physical machine, such as application server 160 which contains the image collection engine 165.

In some embodiments, browser application 112 may make one or more requests from one or more remote servers to provide an image collection to a user. For example, browser application 112 may request a content page from network server 130 and request an image collection from application server 160 which may provide a related image service. In this embodiment, the related image service may be implemented by image collection engine 165 and retrieve images contained in a first set of one or more pages directly linked to the requested content page, a second set of content pages linked to a content page in the first set of content pages, or other content pages related to the requested content page (the context page), such as for example related content pages that are found via a search engine or other search service based on a key word search generated in response to detecting key words in the first or second set of content pages. Image collection engine 160 may identify the related content pages, retrieve image data from application servers 162-166 which provide the related content pages and the image data, and provide an image collection to browser application 112 in response to the request. This is discussed in more detail below.

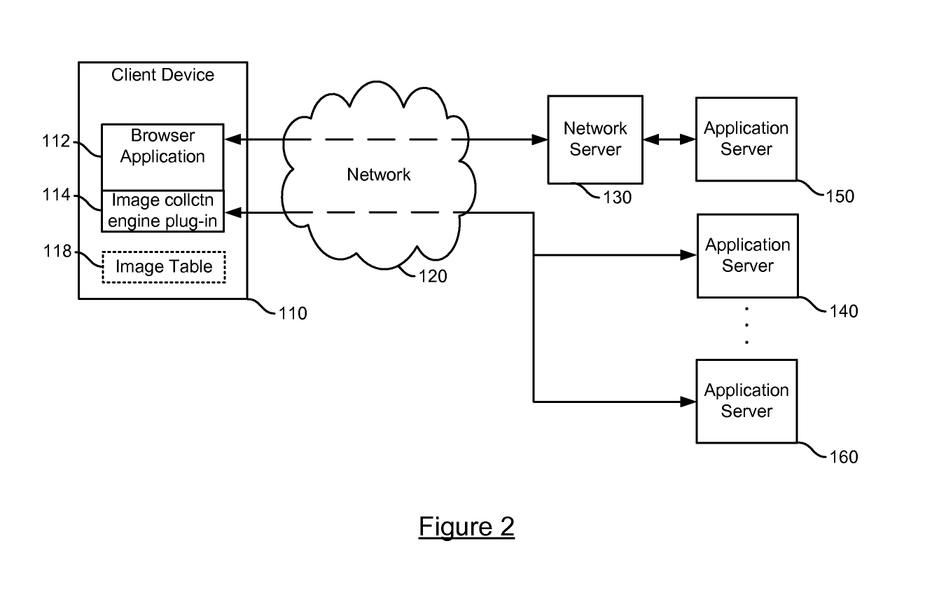

FIG. 2 illustrates a block diagram of another embodiment of a system for providing an image collection. The system of FIG. 2 includes the same client device 110, network 120, network server 130 and application servers 140-160 as the system of FIG. 1. Client device 110 includes browser application 112 and image table 118. Browser application 112 includes image collection engine plug-in 114. Thus, the image collection engine contained in an application server in FIG. 1 is contained in browser application 112 in FIG. 2. Image collection engine plug-in 114 may be used to generate an image collection and may communicate with application servers 140-160 to collect related content page image data.

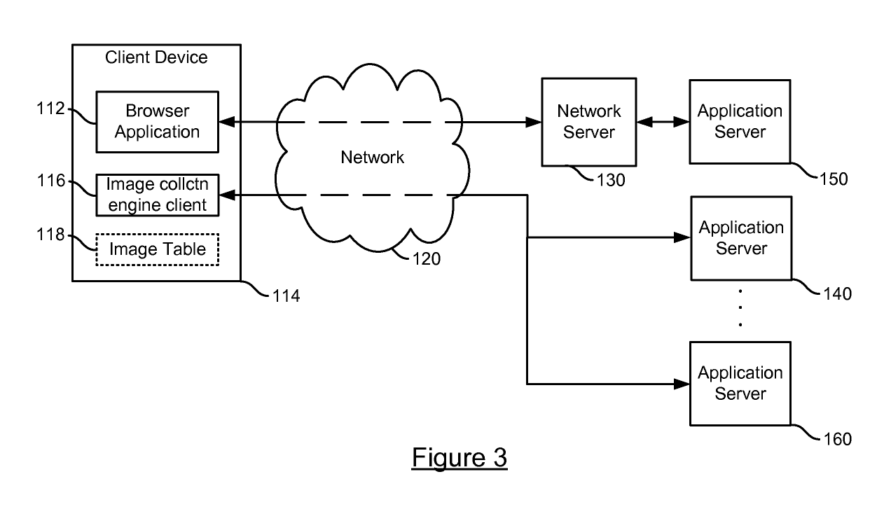

FIG. 3 illustrates a block diagram of another embodiment of a system for providing an image collection. The system of FIG. 3 is similar to that of FIG. 2 except the image collection engine is implemented as client application 116 on client device 114 rather than as a plug-in within a browser application. Image collection client 116 may communicate with browser application 112, application servers 140-160 and image table 118 to retrieve images to include in an image collection.

In some embodiments, as discussed above, image data may be retrieved and placed in an image table. In some embodiments, image data is not stored in a table locally. Rather, a remote service processes related content page data, identifies images to include in an image collection, and provides the image collection to the client requesting the original content page (context page). Use of an image table 118 is therefore optional.

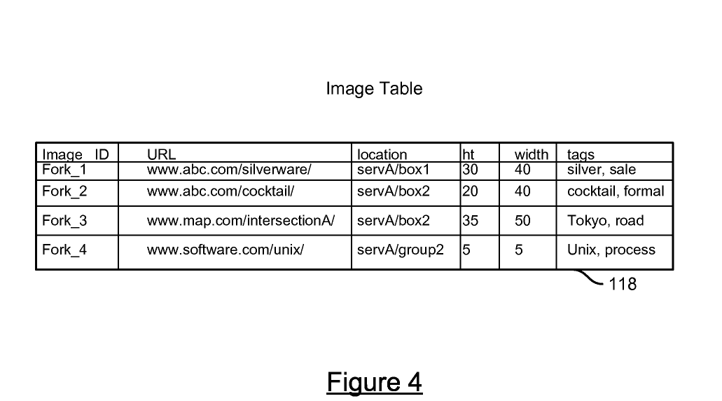

FIG. 4 illustrates an example of an image table 118. In some embodiments, image table 118 of FIG. 4 provides more detail for the image tables in client device 110 in each of FIGS. 1, 2 and 3. The image table 118 of FIG. 4 includes four rows of data and columns of image ID, URL, location, height, width and tags. Other types of data may be included in other columns of the data. The image ID column indicates an identifier for each of several images listed in the table. The identifier may be retrieved from the content page from which the image was received or automatically determined for the image when added to the table. In the table of FIG. 4, the image ID data is fork_1, fork_2, fork_3 and fork_4. The URL column lists a URL at which each image is located. The URLs listed are www.abc.com/silverware/, www.abc.com/cocktail/, www.map.com/intersectionA/, and www.software.com/unix. The location column indicates the location on the client at which the image and associated image information is stored. The locations listed are servA/box1, servA/box2, servA/box2 and servA/group2. The height and width give height data and width data in units of pixels for each image. The heights listed are 30, 20, 35 and 5. The widths listed in the table are 40, 40, 50 and 5. The tags column indicates one or more tags that are associated with each image. The tags may be retrieved from the content page in which the images were originally found. Tags may relate to page context or image properties. Page context tags refer to the content of the image and the page hosting it. Explicit ones like proportions, camera info and aspect ratio, and implicit obtained with image processing like having faces, recognizing items or scenery, and so forth. The tags listed are silver and sale for the first image, cocktail and formal for the second image, Tokyo and road for the third image and Unix and process for the fourth image.

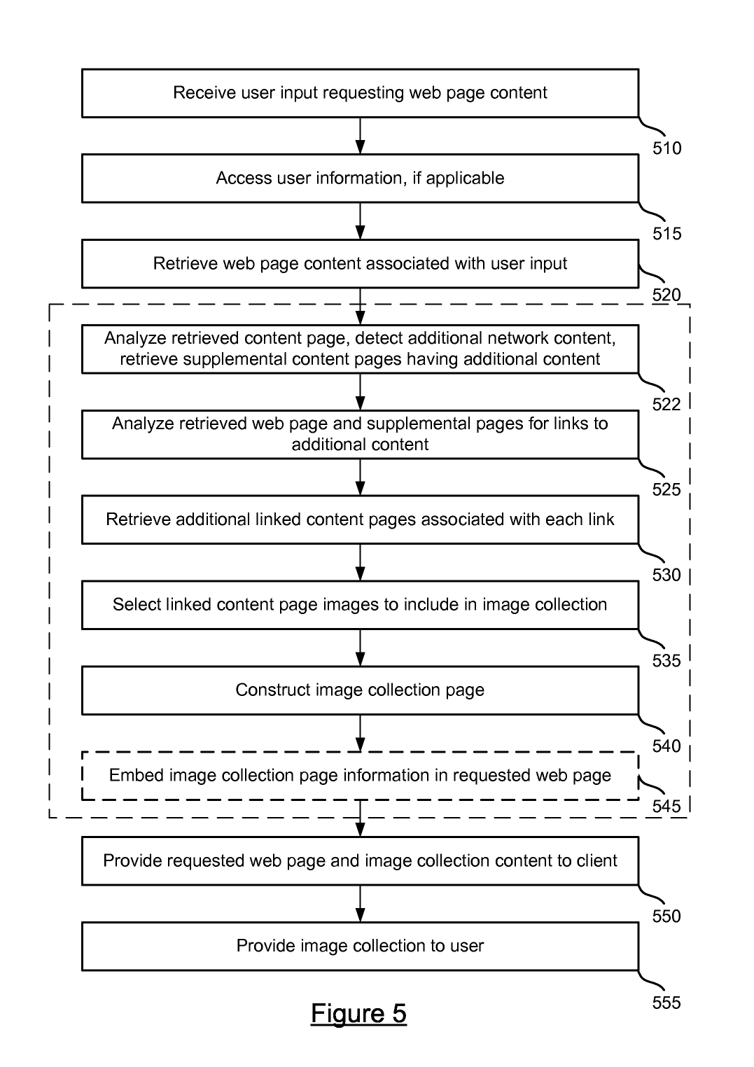

FIG. 5 illustrates an embodiment of a flow chart of a method for generating and providing an image collection. First, user input is received requesting web page content at step 510. The input may be received as a user selects a URL of a web page provided by browser application 112. After receiving user input requesting web page content, user information may be accessed at step 515. User information may include the time zone in which the user is using the browser, any session identification information associated with the user and other user information, such as user settings or other account information from other applications with which browser application 112 may communicate. In some embodiments, no other user information is retrieved and step 515 is optional.

The web page content associated with the user input received at step 510 is retrieved at step 520. To retrieve the content, browser application 112 may send a request to network server 130. Network server 130 receives the request, processes the request and optimally invokes application server 150. Network server 130 then generates a response and provides the response to browser application 112 on client device 110. In some embodiments, the web page content is retrieved from a cached page and offline methods.

Steps 522-545 of the method in FIG. 5 below may be performed by an image collection engine implemented within a client device 110, application server, 160, or some other embodiment of an image collection engine. The different implementations for performing steps 522-545 are indicated by the dashed line encompassing steps 522-545. Additionally, the resulting image collection may be embedded within a content page requested by client device 110 or provided in response to a second request by client device 110, such as for example by application server 160.

The retrieved content page is analyzed and supplemental content pages are retrieved at step 522. The retrieved content page is analyzed for content which may be used to identify content pages having images that may be of interest to a user. In some embodiments, the retrieved content page is analyzed to determine content such as one or more key words. The key words are provided to a search engine which generates a list of content page links for content pages that match the key words. The most relevant of the list of content pages, for example the top five listed content pages, may be retrieved as supplemental content pages.

The retrieved web page and the supplemental content pages are analyzed for links to additional content at step 525. The web pages may be analyzed by an image collection engine implemented on an application server, as a client application, a browser plug-in, or in some other implementation. The image collection engine may analyze the web page by parsing the web page to determine if the web page includes any URLs, semantic information, such as keywords, title, and metadata, or other data.

We assess the relevance of each image to the context page by comparing keywords, title, description etc.; in addition the domain and path to the image and the page hosting the image is another indication of relevance. For example, an image hosted on a different domain (which is not an advertising service) is more likely to contain content than graphics elements. An image coming from pages that are deeper in the site hierarchy is likely to be associated with drill down information. An image located in a separate branch of the site is less likely to be related and therefore will have a lower score and higher chance of being filtered out.

After analyzing the retrieved web pages, additional related content pages associated with each URL link in the retrieved page are retrieved at step 530. Thus, if the image collection engine identified any URLs in the requested content page and supplemental content page, a request is made to those URLs to retrieve the related content page associated with each URL. This step may be repeated for at least another iteration for the retrieved supplemental content pages and pages linked to the first retrieved content page (the context page).

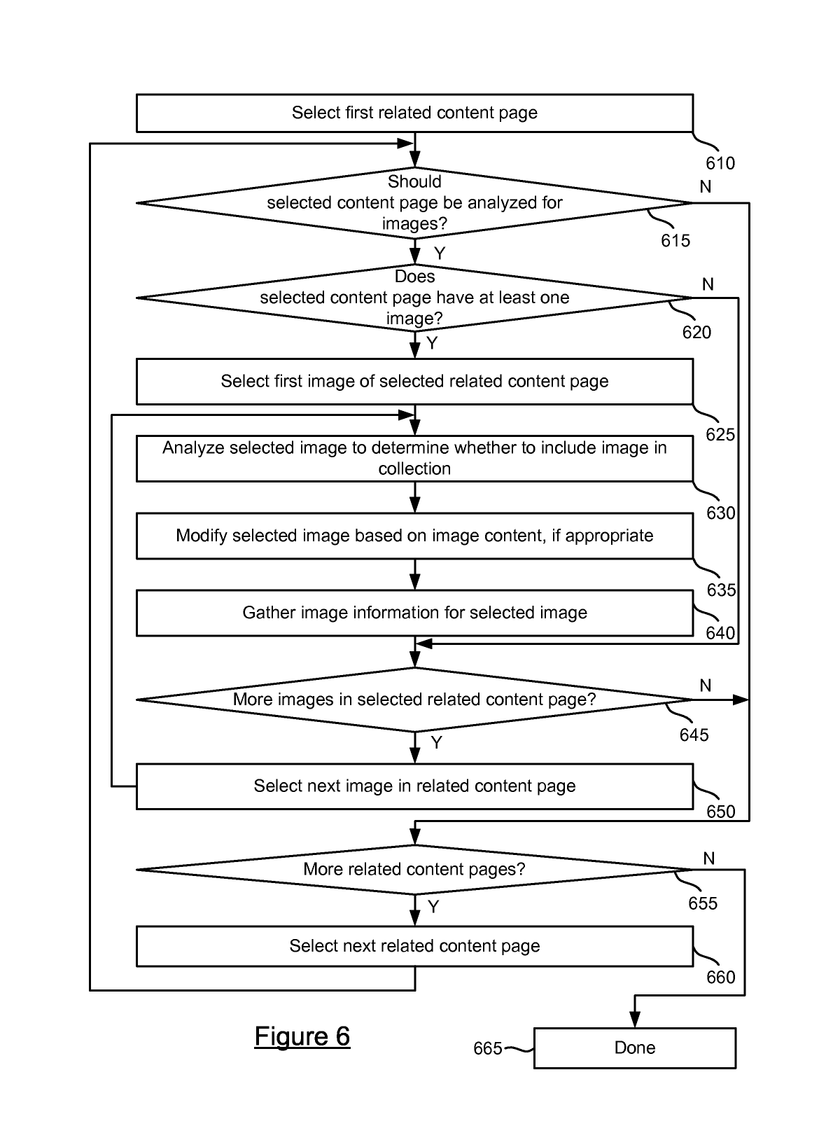

Images in each related content page are selected to include in an image collection at step 535. Images may be selected based on analyzing, modifying, and/or other processing of the images. Selecting related content page images to include in an image collection is discussed in more detail below with respect to FIG. 6.

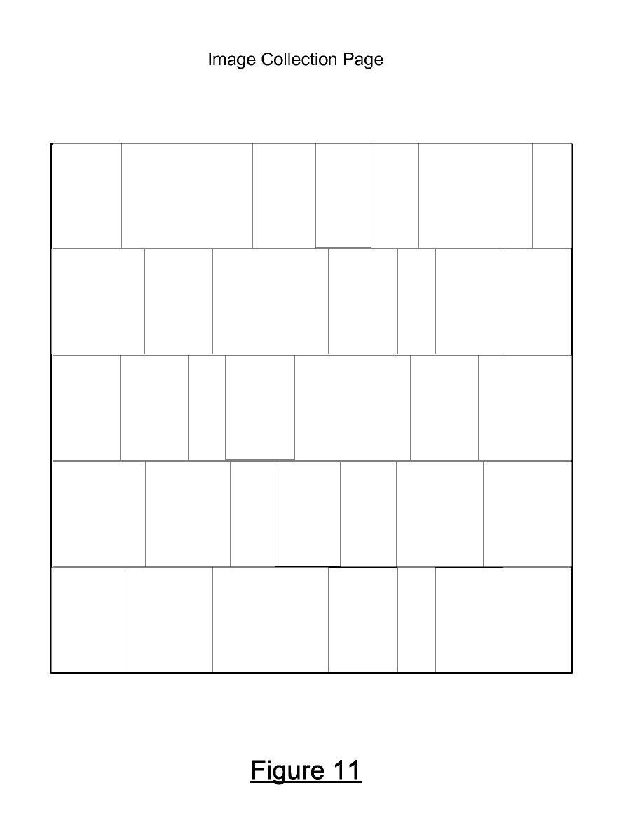

An image collection page is then constructed at step 540. The image collection page is a collage of images originally contained in content pages which are related to the currently provided page and generated by an image collection engine or plug-in. The images in the image collection page may be sorted by contact page, relevance, and/or other factors. In some embodiments, a semantic image can be created from scratch describing the content. An example of an image collection page is provided in FIG. 11 and discussed in more detail below.

An image may be filtered out from the collection if it is too similar to the context page. In some embodiments, the present system may also look for results that are similar to each other. This can be done via clustering algorithms or in some other manner. In one embodiment, when two or more results are similar, the present system only selects a single representative (the one that is more relevant to the context).

In some embodiments, image collection page information is embedded in the requested web page at step 545. The user requested web page received at step 510 is modified to include image collection page information. The embedded information may be a hint, a button in an existing or new toolbar, or some other visual or audio indicator. In some embodiments, a hint may include an icon, a bold, underline or other modified text, highlighted portion of the page or some other hint mechanism. In some embodiments, the embedded information is added to a frame or other portion of a web page. The embedded information may indicate the image collection exists, provide a portion of the page, or include other information.

In some embodiments, the image collection page is not embedded within the content page but provided to browser application 112 as separate data in response to a separate request, such as for example by application server 160. In this embodiment, browser application 112 may receive the separate response containing the image collection data and provide store the response data until providing it through an interface at step 555. Because the image collection can be provided separately and based on a second request made by client device 110, step 545 is optional as indicated by the dashed lines comprising the step.

The requested web page is provided with the embedded image page information at step 550. This is the page retrieved at step 520 above and modified to include embedded image collection information. In some embodiments, providing the requested content page, the context page, and the image collection data includes providing the requested content page with modifications indicating that an image collection page or data is available. The modification may be a highlight of a button, link, or some other modification to the user requested content page.

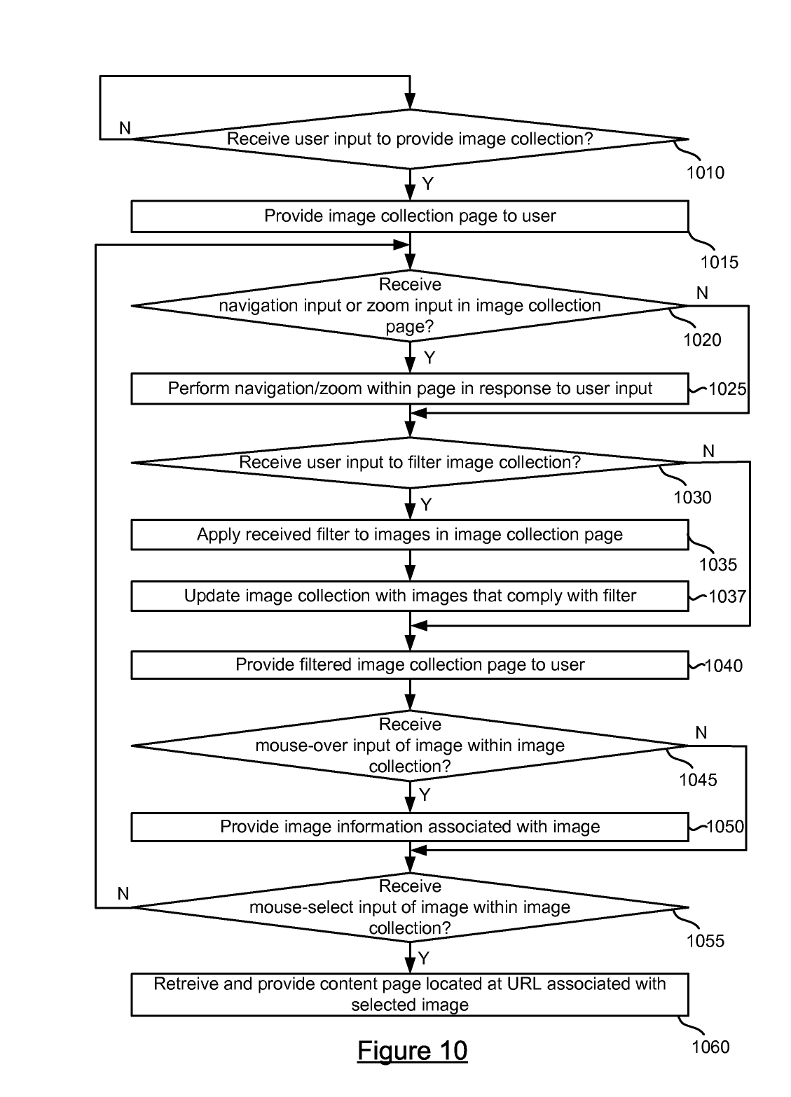

After providing the user requested web page, the image collection page may be provided to the user at step 555. This is the image collection page constructed at step 540 may be provided to the user in response to user input or some other event. Providing the image collection page may include modifying or filtering the page, based on user input or other data. Providing an image collection is discussed in more detail below with respect to FIG. 10. The method of FIG. 5 is then complete until user input is received requesting another web page or information within the image collection page.

In some embodiments, the image collection data is provided in response to a second request transmitted by browser application 112 to image collection engine 165 residing on application server 160. Thus, the image collection engine 165 may provide the image collection data in response to the second request while acting as a “related images” service on application server 160. The response to the second request may include data comprising an image collection. The image collection provided by browser application 121 is generated by the “related images” service in response to a request initiated by user input received through browser application 112 and provided to a user in response to input received through the content page once provided.

FIG. 6 illustrates a flow chart of an embodiment of a method for selecting related content page images to include in an image collection. In some embodiments, the method of FIG. 6 provides more detail for step 535 of the method of FIG. 5. First, a first related content page is selected at step 610. The first related content page is the web page associated with the first of one or more with URL in the content page selected by a user. Next, a determination is made as to whether the selected related content pages are analyzed. For example, related content pages comprised of a certain type of format or document (such as a .pdf document), content pages blocked by a user or a service, or other pages are not analyzed. If the currently selected related content page should be analyzed, a determination is made as to whether the related content page contains one or more images at step 610. In one embodiment, the image collection engine or plug-ins may parse the html of the related content page to determine if it contains an image, for example a .JPEG, GIFF or other recognized image file. If the selected content page does not have any images, the method of FIG. 6 continues to step 645. If the related content page does not have one or more images, the first image is selected at step 625.

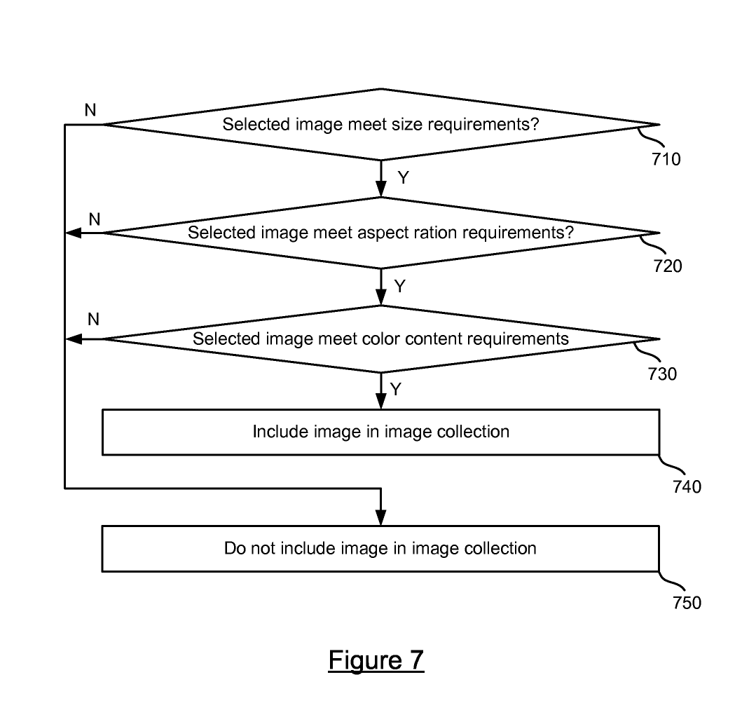

The selected image is analyzed to determine whether to include the image in the image collection at step 630. Analyzing an image may include determining if the image meets size requirements, color requirements, and other requirements for images to include in the image collection. Analyzing a selected image is discussed in more detail below with respect to FIG. 7. If an image is not selected to be included in an image collection, the process continues to step 645 to determine if there are more images to consider.

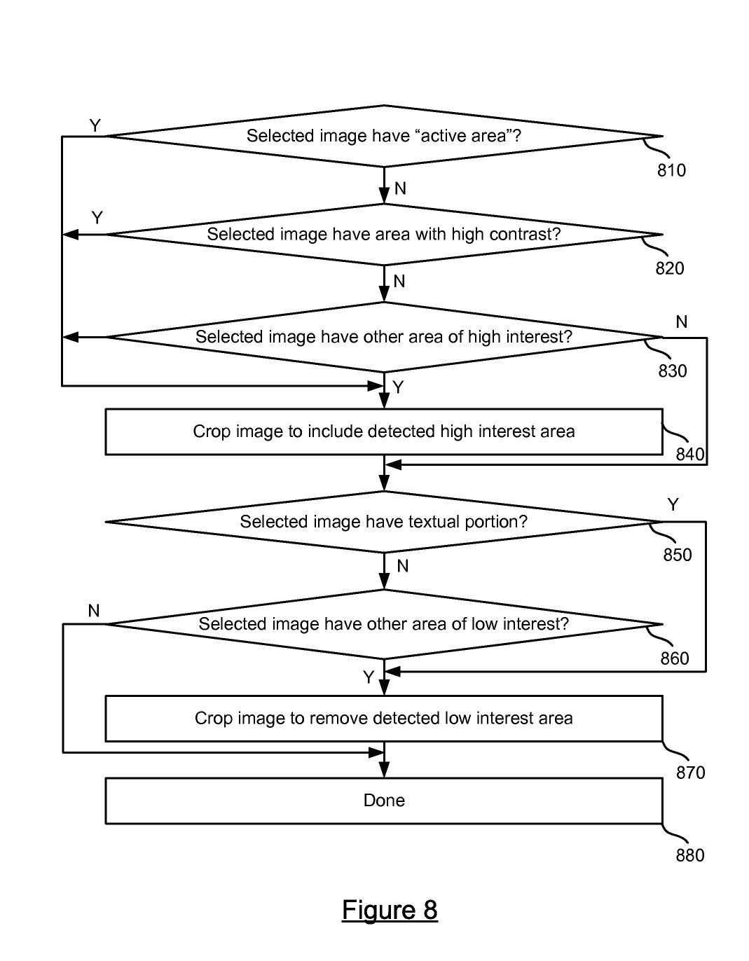

If an image is selected to be included in an image collection at step 630, the image is modified based on content within the image, if needed, at step 635. Modifying the selected image may include cropping the image to remove non-interesting portions or to emphasize more interesting portions of the image. Modifying a selected image is discussed in more detail below with respect to FIG. 8.

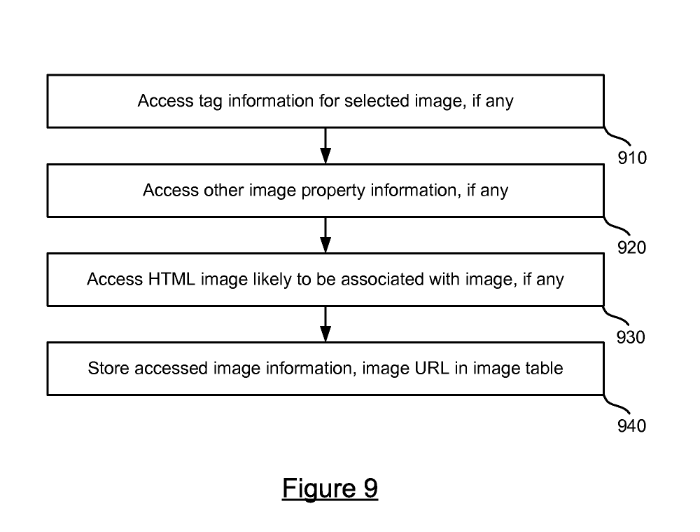

Image information is then gathered for the selected image at step 640. The gathered image information may include image tags, context tags, properties, and other information. This is discussed in more detail below with respect to FIG. 9. Next, a determination is made as to whether more images in the selected related content page exist at step 645. If no more images exist to be processed in the selected related content page, the method of FIG. 6 continues to step 655. If there are additional images in the selected related content page, the next image in the related content page is selected at step 650 and the process of FIG. 6 returns to step 630 to begin analyzing the selected image.

When there are no more images in a selected content page to analyze, a determination is made as to whether there are more related content pages to analyze at step 655. If there are more related content pages, the next related content page is selected at step 660 and the method of FIG. 6 returns to step 615. If there are no more related content pages, the method of FIG. 6 is complete at step 665.

FIG. 7 illustrates a flow chart of an embodiment of a method for analyzing a selected image. In some embodiments, the method of FIG. 7 provides more detail for step 630 of the method of FIG. 6. First, a determination is made as to whether the selected image meets image size requirements at step 710. In some embodiments, there may be a minimum size and maximum size for an image to be included in the image collection. For example, the minimum size may be a minimum size for the viewing content of the image, for example, 20×20 pixels. A maximum size may be some size which comprises one-half of the total screen space of the image collection page or some other proportion. If the selected image does not meet the size requirements, then a determination is made that the image should not be included in the image collection at step 750.

Similarly, for compressed images, the present technology can optionally analyze the compression ratio and only include those images that provide enough detail.

If the image meets the selected image size requirements, a determination is made as to whether the selected image meets aspect ratio requirements at step 720. In some embodiments, the aspect ratio of an image should be one of several standard aspect ratios, such as 4:3, 3:2, 16:9, 1.85:1, 2.39:1, 4:1, 1:4 and other ratios. If the selected image does not meet the aspect ratio requirement, the image is not included in the image collection at step 750. If the image does meet the aspect ratio requirement, then a determination is made as to whether the selected image meets color content requirement at step 730. The color content requirement may require the entire image not be one color, does not have a contrast which includes one or more horizontal lines, or some other color content requirement. If the image does not meet the color content requirements, the image is not included in the image collection at step 750. If the image does meet the color content requirements, the image is included in the image collection at step 740.

In some embodiments, other analysis techniques and filters may be performed on an image to determine if it may be suitable to include in an image collection. For example, an image may be analyzed to identify the image compression ratio. In some embodiments, a less compressed less may have better quality and therefore be preferred for including in an image collection. Additionally, candidate images may be scored according to some criteria, such as by relevance or some other criteria, and the top scored candidates (for example, the top 10) may be included in the image collection.

Properties of the page where the image is embedded are also used for scoring and/or filtering. For example, the domain (is it the same as the context page), and the local path (is it a drill down from the context page, stepping up from the context page, or stepping aside from the context page) can both be considered. An example for scoring a page is extracting the keywords of a page using any known algorithm. The present technology may extract the keywords from both the page given in the input URL and the candidate page we want to score. The more keywords that are similar between both pages, the higher that score that candidate page will have

FIG. 8 illustrates a flow chart of an embodiment of a method for modifying a selected image. In some embodiments, the method of FIG. 8 provides more detail for step 635 of the method of FIG. 6. The steps of the method of FIG. 8 provide several examples of applying image processing techniques to an image to determine the content of the image or a selected image portion. It is intended that these techniques are examples only and that other image processing algorithms generally known in the art can be used to analyze an image.

First, a determination is made as to whether the selected image has an “active area” within the image at step 810. An active area may be determined as a portion of an image that differs from its surrounding pixels or majority of the remainder of the image, such as a person standing in front of a wall. If the selected image has an active area, then the method of FIG. 8 continues to step 840 where the image is cropped to include the active area or a detected high interest area. If the selected image does not have an active area, a determination is made as to whether the selected image has an area with high contrast at step 820. If the selected image does not have a high contrast area, the method continues to step 830. If the image does have an area of high contrast, then the method continues to step 840.

A determination is made as to whether the second image has an area of high interest as determined by other means at step 830. These also can affect the filtering of the image, but are compute intensive for the basic inspection. Examples of other areas of high interest include facial recognition, edge detection, filtering, threshold processing, and other methods. If the selected image has an area of high interest at step 830, then the image is cropped to include the detected high interest area at step 840. If the selected image does not have an area of high interest, a determination is made as to whether the selected image has a textual portion of graphics at step 850. The selected image may have graphics that form text, which is generally of low interest. If the selected image does have a graphic, textual portion, then the image is cropped to remove the detected low interest portion graphic text at step 870. If the selected image does not have a textual graphic portion, a determination is made as to whether the selected image has some other area of low interest at step 860. Areas of low interest may be determined using methods known in the field of image processing, similar to those listed above to determine high interest areas. If the image does not have any other area of low interest, the method of FIG. 8 is complete at step 880. If the selected image does have an area of low interest at step 860, the image is cropped to remove the detected low interest area at step 870 and the method is complete at step 880.

FIG. 9 illustrates a flow chart of an embodiment of a method for gathering image information. In some embodiments, the present technology will access HTML information first and then process the information, as this may prevent a download of an image. After the processing, the image properties and tags that don't require image processing are accessed. Only at the end is image processing used, as image processing methods typically use extensive computer resources.

The method of FIG. 9 provides more detail for step 640 of the method of FIG. 6. First, tag information for a selected image is accessed at step 910. In some embodiments, some images may not have tag information. If this is the case, no information is accessed at step 910. Next, image property information may be accessed, if any, at step 920. Image property information may include the date the image was created, any description information for the image, image name, identifier, or some other information. Next, any HTML data likely to be associated with the image is accessed at step 930. In some embodiments, an image is positioned in a content page with text displayed in the immediate vicinity of the image. The text may describe the image or provide other information with the image. The text may be retrieved at step 930. After accessing any image information, the accessed image information is stored along with the image URL in image table 118 at step 940.

FIG. 10 illustrates a flow chart of an embodiment of a method for providing an image collection to a user. First, a determination is made as to whether user input is received to provide the image collection to a user at step 1010. If no user input is received, the method of FIG. 10 remains at step 1010. If user input is received to provide the image collection, the image collection page is provided to a user a step 1015. The image collection may be provided in a new window, a portion of the current window, or in some other way. In some embodiments, user input may also indicate (implicitly and explicitly) how relevant the image collection is to the user. Such user feedback regarding the relevance of the served suggestions can be integrated into a closed loop system. An example of an image collection is discussed in more detail below with respect to FIG. 11.

Next, a determination is made as to whether navigation and/or zoom input is received for the image collection page at step 1020. Navigational input may include an input to move or scroll the page within the image to the left, right, up or down. Zoom input may include input to either zoom in to view a closer up view of the image or to zoom out to view more of the image at less detail. If input is not received at step 1020, the method of FIG. 10 continues to step 1030. If the input is received, then the navigation or zoom input is performed within the image collection page in response to received user input. The method of FIG. 10 then continues to step 1030.

A determination is made as to whether user input to filter the image collection images has been received at step 1030. A user may provide input to adjust the image collection after the image collection is initially displayed for the user. User input to filter the collection images may include input to filter the images by the image date, tags associated with the image, image description information, or other information. If no user input is received to filter the image collection, the method of FIG. 10 continues to step 1045. If input is received to filter the image collection, the received user input is used to filter the images in the image collection page at step 1035. Applying the filter to the images may result in one or more images being removed from the image collection that did not satisfy or comply with the filter. Next, the image collection page is updated with the remaining images which were not filtered out at step 1037. Image filtering may be performed by an image collection engine, plug-in or client or some other software. The filtered image collection page is provided to a user at step 1040.

A determination is made as to whether a mouse over input is received for an image within the image collection at step 1045. A mouse over input may include positioning a cursor over an image and keeping the cursor in that position for two or more seconds. If a mouse over input is not received, the method of FIG. 10 continues to step 1055. If the mouse over input is received, the image information associated with the image is provided at step 1050. The provided image information includes URL information, image description information, tags, properties, or some other information. The process of FIG. 10 then continues to step 1055.

A determination is made as to whether a mouse select input is received for an image within the image collection at step 1055. The mouse select input may include a left or right mouse click while the cursor is placed over an image within the image collection. If no mouse select input is received at step 1055, the method of FIG. 10 returns to step 1020. If a mouse select input is received, the content page associated with the URL for the selected image is retrieved and provided to the user at step 1060.

FIG. 11 illustrates an example of an image collection. The image collection of FIG. 11 illustrates 5 rows of images. The images in each row have the same height but may have a different width. In some embodiments, the images may be placed in columns that have the same width but a different height. In some embodiments, the images may all have the same height and width or a different height and width. The size of the images in the image collection may depend on the original image in the related content page, a level of interest in the image as determined from image processing techniques known in the art, and other factors.

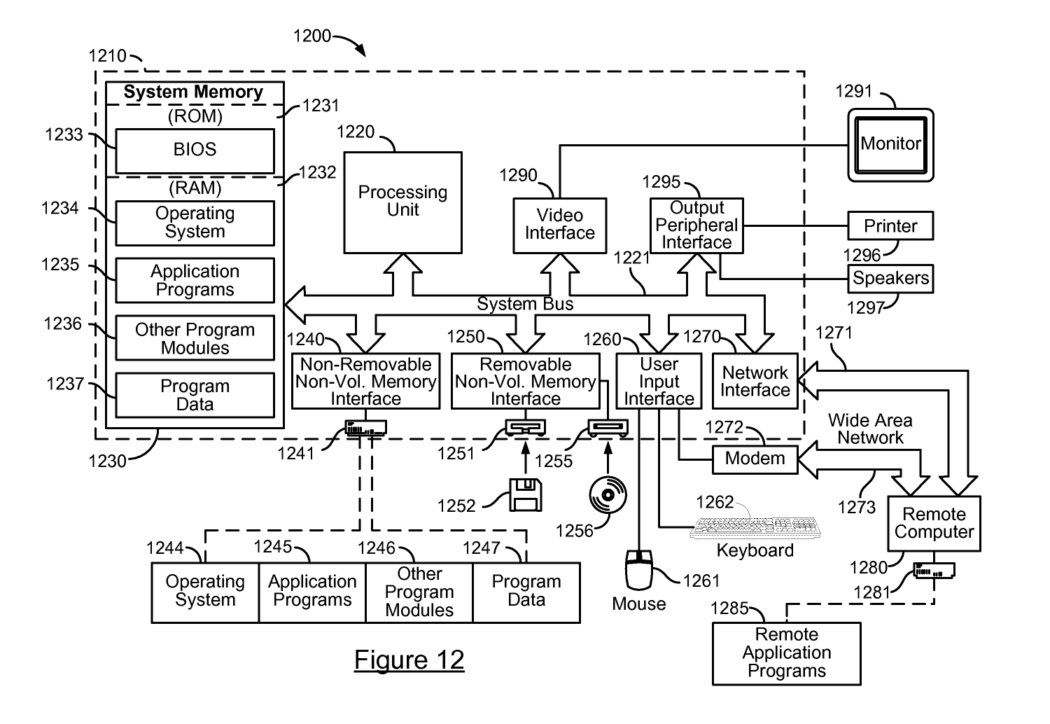

FIG. 12 illustrates an embodiment of a computing environment used with the present technology. In some embodiments, the computing environment of FIG. 12 provides more detail for client device 110, network server 130, application servers 140, 150 and 160, and back end server 170.

FIG. 12 illustrates a block diagram of an embodiment of a computing environment 1200. In some embodiments, the computing environment of FIG. 12 may provide more detail for client device 110, network server 130, application servers 14-160, and backend server 170.

Computing environment 1200 of FIG. 12 is only one example of a suitable computing environment and is not intended to suggest any limitation as to the scope of use or functionality of the technology herein. Neither should the computing environment 1200 be interpreted as having any dependency or requirement relating to any one or combination of components illustrated in the exemplary operating environment 1200.

The technology described herein is operational with numerous other general purpose or special purpose computing system environments or configurations. Examples of well known computing systems, environments, and/or configurations that may be suitable for use with the technology herein include, but are not limited to, personal computers, server computers, hand-held or laptop devices, mobile phones or devices, multiprocessor systems, microprocessor-based systems, set top boxes, programmable consumer electronics, network PCs, minicomputers, mainframe computers, distributed computing environments that include any of the above systems or devices, and the like.

The technology herein may be described in the general context of computer-executable instructions, such as program modules, being executed by a computer. Generally, program modules include routines, programs, objects, components, data structures, and so forth that perform particular tasks or implement particular abstract data types. The technology herein may also be practiced in distributed computing environments where tasks are performed by remote processing devices that are related through a communications network. In a distributed computing environment, program modules may be located in both local and remote computer storage media including memory storage devices.

With reference to FIG. 12, an exemplary system for implementing the technology herein includes a general purpose computing device in the form of a computer 1210. Components of computer 1210 may include, but are not limited to, a processing unit 1220, a system memory 1230, and a system bus 1221 that couples various system components including the system memory to the processing unit 1220. The system bus 1221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, AGP, PCIE, and Peripheral Component Interconnect (PCI) bus also known as Mezzanine bus.

Computer 1210 typically includes a variety of computer readable media. Computer readable media can be any available media that can be accessed by computer 1210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1230 includes computer storage media in the form of volatile and/or nonvolatile memory such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data and/or program modules that are immediately accessible to and/or presently being operated on by processing unit 1220. By way of example, and not limitation, FIG. 12 illustrates operating system 1234, application programs 1235, other program modules 1236, and program data 1237.

The computer 1210 may also include other removable/non-removable, volatile/nonvolatile computer storage media. By way of example only, FIG. 12 illustrates a hard disk drive 1240 that reads from or writes to non-removable, nonvolatile magnetic media, a magnetic disk drive 1251 that reads from or writes to a removable, nonvolatile magnetic disk 1252, and an optical disk drive 1255 that reads from or writes to a removable, nonvolatile optical disk 1256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1241 is typically connected to the system bus 1221 through a non-removable memory interface such as interface 1240, and magnetic disk drive 1251 and optical disk drive 1255 are typically connected to the system bus 1221 by a removable memory interface, such as interface 1250.

The drives and their associated computer storage media discussed above and illustrated in FIG. 12, provide storage of computer readable instructions, data structures, program modules and other data for the computer 1210. In FIG. 12, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237. Operating system 1244, application programs 1245, other program modules 1246, and program data 1247 are given different numbers here to illustrate that, at a minimum, they are different copies. A user may enter commands and information into the computer 120 through input devices such as a keyboard 1262 and pointing device 1261, commonly referred to as a mouse, trackball or touch pad. Other input devices (not shown) may include a microphone, joystick, game pad, satellite dish, scanner, or the like. These and other input devices are often connected to the processing unit 1220 through a user input interface 1260 that is coupled to the system bus, but may be connected by other interface and bus structures, such as a parallel port, game port or a universal serial bus (USB). A monitor 1291 or other type of display device is also connected to the system bus 1221 via an interface, such as a video interface 1290. In addition to the monitor, computers may also include other peripheral output devices such as speakers 1297 and printer 1296, which may be connected through an output peripheral interface 1290.

The computer 1210 may operate in a networked environment using logical connections to one or more remote computers, such as a remote computer 1280. The remote computer 1280 may be a personal computer, a server, a router, a network PC, a peer device or other common network node, and typically includes many or all of the elements described above relative to the computer 1210, although only a memory storage device 1281 has been illustrated in FIG. 12. The logical connections depicted in FIG. 12 include a local area network (LAN) 1271 and a wide area network (WAN) 1273, but may also include other networks. Such networking environments are commonplace in offices, enterprise-wide computer networks, intranets and the Internet.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. The modem 1272, which may be internal or external, may be connected to the system bus 1221 via the user input interface 1260, or other appropriate mechanism. In a networked environment, program modules depicted relative to the computer 1210, or portions thereof, may be stored in the remote memory storage device. By way of example, and not limitation, FIG. 12 illustrates remote application programs 1285 as residing on memory device 1281. It will be appreciated that the network connections shown are exemplary and other means of establishing a communications link between the computers may be used.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A computer implemented method for providing a content page, comprising:
receiving content page data for a first content page requested by a user;
parsing the content page data for identification information for one or more related content pages;
retrieving one or more related content pages, the one or more related content pages including a first set of one or more content pages directly linked to the received content page and a second set of one or more content pages that are directly linked to one or more content pages in the first set of one or more content pages;
detecting one or more images in the one or more related content pages;
selecting at least one of the one or more images to include in an image collection; and
providing the image collection to the user.

2. The computer implemented method of claim 1, wherein the content page data is received from a web server in response to user input.

3. The computer implemented method of claim 1, wherein said step of parsing includes:
parsing html content page data to identify one or more URLs in a content page in one of HTML, flash, XML, Silverlight, and javascript format.

4. The computer implemented method of claim 1, wherein said step of detecting one or more images includes:
identifying one or more files in the related content pages which match a set of known image formats.

5. The computer implemented method of claim 1, wherein said step of selecting at least one of the one or more images includes:
determining if the one or more images complies with a size threshold, an aspect ratio threshold or a compression rate threshold.

6. The computer implemented method of claim 1, wherein said step of selecting at least one of the one or more images includes:
determining if the text associated with one or more images partially matches the keywords, title, and description of the context page.

7. The computer implemented method of claim 1, further including:
modifying a selected image to be included in the image collection.

8. The computer implemented method of claim 7, wherein said step of modifying includes:
cropping the selected image to remove a low interest portion of the image.

9. The computer implemented method of claim 1, wherein said step of providing an indicator for the image collection includes:
providing an indicator for the image collection in the first content page.

10. The computer implemented method of claim 1, wherein said step of providing an indicator for the image collection includes:
providing an indicator associated with the image collection in a toolbar of a browser application providing the content page.

11. The computer implemented method of claim 1, further comprising:
receiving a selection from a user of an image in the image collection; and
providing the related content page to the user which includes the selected image.

12. One or more processor readable storage devices having processor readable code embodied on said processor readable storage devices, said processor readable code for programming one or more processors to perform a method comprising:
retrieving a first content page;
detecting one or more related content pages for the first content page;
retrieving one or more images from the one or more related content pages; and
providing the one or more images in an image collection.

13. One or more processor readable storage devices according to claim 12, wherein said step of detecting one or more related content pages includes:
parsing html code for a first web page; and
identifying one or more URL links to other web pages within the html code for the first web page.

14. One or more processor readable storage devices according to claim 13, wherein the method further comprises:
comparing the retrieved images to one or more thresholds;
selecting the images that satisfy each of the one or more thresholds, the selected images comprising the one or more images in the image collection.

15. One or more processor readable storage devices according to claim 14, wherein the method further comprises:
processing the selected images to determine content characteristics;
modifying at least one selected image based on the determined content characteristics for that image.

16. One or more processor readable storage devices according to claim 14, wherein said step of providing the one or more images includes:
receiving user input to filter the one or more images in the image collection;
applying a filter to the one or more images based on the user input; and
generating a second image collection based on a modified set of one or more images, each of the images in modified set of one or more images satisfying the filter based on the user input, wherein the user input includes filtering input or pivoting input.

17. An apparatus for providing a content page, comprising:
a storage device;
a communication interface for communicating over a network;
a browser application stored on said storage device and configured to provide a content page based on content received through the communication interface; and
an image collection engine stored on said storage device and configured to process a first content page to identify one or more content pages related to the first content page, retrieve images contained in the one or more related content pages and generate an image collection containing a selected set of the images, the images retrieved by the image collection engine through the communication interface.

18. The apparatus of claim 17, wherein said image collection engine is implemented as a plug-in for said browser application.

19. The apparatus of claim 17, wherein said image collection engine is implemented as a client application stored on said storage device.

20. The apparatus of claim 17, wherein said image collection engine is implemented as an application stored on an application server in communication with a client device, the image collection configured to be transmitted to the client device by the application server.
